(19) United States
(12) Patent Application Publication
(10) Pub. No.: US 2026/0195372 A1
(43) Pub. Date: Jul. 9, 2026

(54) DATA INTEGRATION ASSISTANCE METHOD, DATA INTEGRATION ASSISTANCE DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Akihiro NODA, Osaka (JP); Yasunori ISHII, Osaka (JP); Shota ONISHI, Osaka (JP)

(21) Appl. No.: 19/553,861

(22) Filed: Mar. 2, 2026

Related U.S. Application Data
(63) Continuation of application No. PCT/JP2024/028895, filed on Aug. 13, 2024.

(30) Foreign Application Priority Data
Sep. 7, 2023 (JP) 2023-145444

(51) Int. Cl. G06F 16/538; G06F 16/55; G06F 16/583

(52) U.S. Cl. CPC G06F 16/538; G06F 16/55; G06F 16/583

(57) ABSTRACT

A data integration assistance device acquires purpose information indicating a purpose of a user with respect to data integration in which an additional dataset is added to an existing dataset owned by the user, searches for an additional candidate dataset that matches the purpose from candidate datasets on the basis of the purpose information, generates a presentation screen image visualizing a feature for a case where the additional candidate dataset is added to the existing dataset, and outputs the presentation screen image to a display.

### FIELD OF INVENTION

The present disclosure relates to a technique of assisting data integration.

### BACKGROUND ART

Patent Literature 1 discloses a method for identifying reusable project components for building a new project. Specifically, Patent Literature 1 discloses extracting a current requirement of a new project from data sources by using natural language processing (NLP), detecting an existing requirement similar to the current requirement by performing semantic analysis of the current requirement and the existing requirement, determining a similarity score for the existing requirement on the basis of a similarity between the current requirement and the existing requirement, and extracting, on the basis of the similarity score, a project component associated with the existing requirement, the extracted project component being a reusable project component for building the new project.

However, in the technique of Patent Literature 1, a project component that is unilaterally reusable by a machine is extracted, and a purpose of a user for the project is not considered at all. Therefore, the technique of Patent Literature 1 has a problem that data integration that matches the purpose of the user cannot be implemented.

Patent Literature 1: JP 7007486 B2

### SUMMARY OF THE INVENTION

The present disclosure has been made in view of such a problem, and provides a technique capable of implementing data integration that matches a purpose of a user.

A data integration assistance method according to one aspect of the present disclosure includes, by a computer, acquiring purpose information indicating a purpose of a user with respect to data integration in which an additional dataset is added to an existing dataset owned by the user, searching for an additional candidate dataset that matches the purpose from candidate datasets on the basis of the purpose information, generating a presentation screen image visualizing a feature of an integrated dataset obtained by adding the additional candidate dataset to the existing dataset, and outputting the presentation screen image to a display.

The present disclosure allows data integration that matches a purpose of a user to be implemented.

### BRIEF DESCRIPTION OF THE DRAWINGS

FIG. 1 is a block diagram illustrating one example of a configuration of a data integration assistance system according to an embodiment of the present disclosure.

FIG. 2 is a flowchart illustrating one example of processing of a server according to the present embodiment.

FIG. 3 is a diagram illustrating an example of a presentation screen image.

FIG. 4 is a diagram illustrating details of a sample field and a map field.

### DETAILED DESCRIPTION

### Knowledge Underlying Present Disclosure

In recent years, a learned model suitable for a task that a user wants to solve has been generated by transfer learning of a general-purpose base model obtained by self-supervised learning (SSL) of common base data available in various businesses. In order to obtain learning data at the time of transfer learning, if an additional dataset suitable for a task that the user wants to solve is extracted from enormous data accumulated in a large database in a company, the development period of the learned model can be shortened and the development cost can be reduced.

However, it is not easy for a machine to extract additional datasets that match the purpose of data integration of the user from a large database.

For example, in a case where the existing dataset includes a large number of datasets of “dogs” and “cats” and the user desires to “recognize not only dogs and cats but also birds”, the user desires to extract a dataset of birds from the large database as the additional dataset. On the other hand, in a case where the existing dataset includes a large number of datasets of “dog” and “cat”, and it is desired to improve the recognition accuracy of “dog” and “cat”, the user desires to further add the datasets of “dog” and “cat” from the large database. In this manner, the purpose of the data integration varies depending on the task that the user wants to solve. Therefore, it is not easy for a machine to unilaterally extract additional datasets that match the purpose of data integration of the user from a large database.

In a case where the technique described in Patent Literature 1 is applied to such data integration, since the machine extracts the additional dataset on the basis of a one-sided criterion, there is a problem that data integration that matches the purpose of the user cannot be implemented.

The present disclosure has been made in order to solve such a problem.
(1) A data integration assistance method according to one aspect of the present disclosure includes, by a computer, acquiring purpose information indicating a purpose of a user with respect to data integration in which an additional dataset is added to an existing dataset owned by the user, searching for an additional candidate dataset that matches the purpose from candidate datasets on the basis of the purpose information, generating a presentation screen image visualizing a feature of an integrated dataset obtained by adding the additional candidate dataset to the existing dataset, and outputting the presentation screen image to a display.

In this configuration, the additional candidate dataset that matches the purpose indicated by the purpose information is searched for from the candidate dataset on the basis of the purpose information, and the presentation screen image visualizing the feature of the integrated dataset obtained by adding the candidate dataset to the existing dataset is output to the display. Therefore, the user can know an influence of the additional candidate dataset on the existing dataset through the presentation screen image and confirm whether the additional candidate dataset matches the purpose. As a result, the present disclosure allows data integration that matches the purpose of the user to be implemented.
(2) In the data integration assistance method according to (1), the presentation screen image may include a first distribution indicating a distribution of feature amounts of existing data constituting the existing dataset in a feature space, and a second distribution indicating a distribution of feature amounts of integrated data constituting the integrated dataset in the feature space.

In this configuration, since the first distribution indicating the distribution of the feature amounts of the existing dataset and the second distribution indicating the distribution of the feature amounts of the integrated dataset are displayed on the presentation screen image, it is possible to allow the user to quantitatively confirm the influence of the additional candidate dataset on the existing dataset.
(3) In the data integration assistance method according to (1) or (2), the presentation screen image may include a plurality of samples for each of a plurality of clusters of the integrated dataset, the plurality of samples being obtained by clustering the integrated dataset into the plurality of clusters.

In this configuration, since the samples for each of the clusters of the clustered integrated dataset are presented, it is possible to allow the user to more specifically confirm the influence of adding the additional candidate dataset.
(4) The data integration assistance method according to (3) may further include, in a case where an instruction of the user to designate an unnecessary sample from the plurality of samples is received, deleting additional candidate data included in a cluster to which the unnecessary sample belongs from the additional candidate dataset, and updating the integrated dataset by using the additional candidate dataset having been deleted, and updating the presentation screen image by using the integrated dataset having been updated.

This configuration can cause the user to easily delete unnecessary additional candidate data from the additional candidate dataset, and cause the user to recognize a change in influence due to the deletion.
(5) The data integration assistance method according to any of (1) to (4) may further include, in a case where additional purpose information with respect to the data integration is acquired, re-searching for the additional candidate dataset from the candidate dataset on the basis of the additional purpose information, and updating the integrated dataset by using the additional candidate dataset having been re-searched for, and updating the presentation screen image by using the integrated dataset having been updated.

This configuration can interactively re-search the additional candidate dataset while considering the additional purpose of the user who has browsed the presentation screen image, and allow the user to recognize the change in the feature after the re-search.
(6) In the data integration assistance method according to any of (1) to (5), the searching may include searching for an additional candidate dataset that matches the purpose by comparing a feature amount of the purpose information with a feature amount of candidate data constituting the candidate dataset.

In this configuration, since the additional candidate dataset that matches the purpose is searched for by comparing the feature amount of the existing data with the feature amount of the candidate data, the additional candidate data that matches the purpose can be accurately searched for.
(7) In the data integration assistance method according to any of (1) to (6), the searching may include calculating a matching degree for each of a plurality of search conditions for each of a plurality of the candidate data constituting the candidate dataset, and combining the matching degrees to calculate a matching score for the purpose for each of the plurality of candidate data, and searching for, as the additional candidate dataset, a dataset including the candidate data having a matching score exceeding a threshold.

In this configuration, it is possible to accurately search the additional candidate dataset that matches the purpose.
(8) In the data integration assistance method according to any of (1) to (7), the feature amount may include a plurality of categorized feature amounts of different categories, and in a case where an instruction to select one categorized feature amount from the plurality of categorized feature amounts is received, the presentation screen image may display the feature of the integrated dataset for the one categorized feature amount.

This configuration can cause the user to confirm the influence of adding the additional candidate data through the presentation screen image for each categorized feature amount.
(9) In the data integration assistance method according to (7), each of the existing dataset and the candidate dataset may include image data, and the plurality of categorized feature amounts may include at least two of a vector feature amount obtained by inputting the image data to a learned model, meta information of the image data, a luminance distribution of the image data, or annotation information.

This configuration allows the user to confirm the additional dataset that matches the purpose with respect to any of the vector feature amount, the meta information, the luminance distribution, or the annotation information.
(10) In the data integration assistance method according to (9), the meta information may include at least one of a size of the image data, an aspect ratio of the image data, or an acquisition date and time of the image data.

This configuration allows the user to confirm the additional dataset that matches the purpose with respect to any of the size, the aspect ratio, or the acquisition date and time.
(11) In the data integration assistance method according to (9) or (10), the annotation information may include, for each dataset of the existing dataset and the additional candidate dataset, at least one of a ratio of a class to which an object indicated by an annotation added to the image data belongs in the dataset, a ratio of the image data having been annotated in the dataset, or an error rate of the annotation in the dataset.

This configuration allows the user to confirm the additional dataset that matches the purpose with respect to any one of the ratio of the class, the ratio of the image data on which the annotation has been performed, or the error rate with respect to the annotation.
(12) In the data integration assistance method according to any of (1) to (11), each of the existing dataset and the additional dataset may be a dataset for machine learning.

This configuration can cause the user to confirm the additional candidate dataset that matches the purpose of the user in the machine learning.
(13) In the data integration assistance method according to (2), the second distribution may include a plurality of distributions corresponding to a plurality of clusters obtained by clustering the additional candidate data constituting the additional candidate dataset.

This configuration can provide the user with an index indicating which additional candidate data of the additional candidate datasets is unnecessary.
(14) A data integration assistance device according to another aspect of the present disclosure includes a processor, in which the processor acquires purpose information indicating a purpose of a user with respect to data integration in which an additional dataset is added to an existing dataset owned by the user, searches for an additional candidate dataset that matches the purpose from candidate datasets on the basis of the purpose information, generates a presentation screen image visualizing a feature of an integrated dataset obtained by adding the additional candidate dataset to the existing dataset, and outputs the presentation screen image to a display.

This configuration can provide a data integration assistance device that implements data integration that matches the purpose of the user.
(15) A data integration assistance program according to another aspect of the present disclosure causes a computer to execute processing of acquiring purpose information indicating a purpose of a user with respect to data integration in which an additional dataset is added to an existing dataset owned by the user, searching for an additional candidate dataset that matches the purpose from candidate datasets on the basis of the purpose information, generating a presentation screen image visualizing a feature of an integrated dataset obtained by adding the additional candidate dataset to the existing dataset, and outputting the presentation screen image to a display.

This configuration can provide a data integration assistance program that implements data integration that matches the purpose of the user.

The present disclosure can also be implemented as a data integration assistance system that operates by such a data integration assistance program. It is needless to say that such a computer program can be distributed via a computer-readable non-transitory recording medium such as a CD-ROM or via a communication network such as the Internet.

Note that each of embodiments to be described below illustrates a specific example of the present disclosure. Numerical values, shapes, constituent elements, steps, order of steps, and the like of the embodiments below are merely examples, and are not intended to limit the present disclosure. A constituent element not described in an independent claim representing a highest concept among constituent elements in the embodiments below is described as an optional constituent element. In all the embodiments, the contents can be combined.

### Embodiments

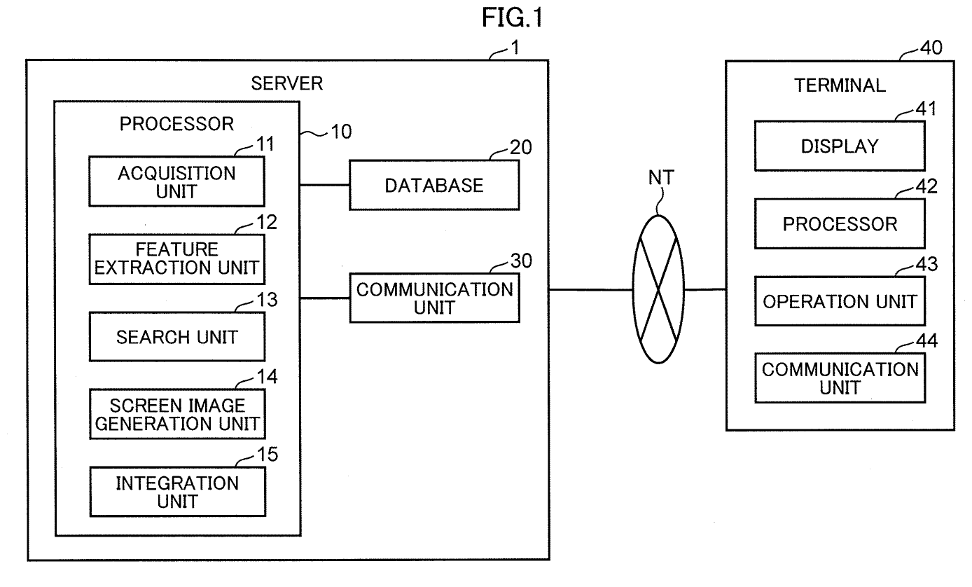

FIG. 1 is a block diagram illustrating one example of a configuration of a data integration assistance system according to an embodiment of the present disclosure. The data integration assistance system includes a server 1 (an example of a data integration assistance device) and a terminal 40. The server 1 and the terminal 40 are communicably connected to each other via a network NT. An example of the network NT is the Internet. The server 1 is, for example, a cloud server configured by one or a plurality of computers. The terminal 40 is a computer used by a user. An example of the terminal 40 is a desktop computer or a portable computer such as a tablet computer and a smartphone.

The server 1 includes a processor 10, a database 20, and a communication unit 30. An example of the processor 10 is a central processing unit (CPU). The processor 10 includes an acquisition unit 11, a feature extraction unit 12, a search unit 13, a screen image generation unit 14, and an integration unit 15. The acquisition unit 11 to the integration unit 15 are implemented by the processor executing a data integration assistance program. However, this configuration is merely an example, and the acquisition unit 11 to the integration unit 15 may be configured by a dedicated hardware circuit.

The acquisition unit 11 acquires purpose information indicating a purpose of the user with regard to data integration in which an additional dataset is added to an existing dataset owned by the user. An example of the purpose information is a keyword indicating a feature of a dataset to be added. As the keyword, for example, a keyword indicating a scene such as “construction site”, “highway”, or “general road”, or a keyword indicating a class (for example, a dog, a cat, a bird, or the like) to be added can be adopted.

An example of the purpose information is meta information such as an image size to be added as a dataset. Details of the meta information will be described later. As an example of the purpose information, a request message indicating what kind of feature dataset is desired as the additional dataset can be adopted in view of a balance with the feature of the existing dataset. In a case where the user desires a dataset including a class not included in the existing dataset or a small number of classes as the additional dataset, a message such as “I want data for general-purpose recognition” is adopted as the request message. In a case where the user desires to further enrich data of the class included in the existing dataset as the additional dataset, a message such as “I want data specialized for the current class” is adopted as the request message.

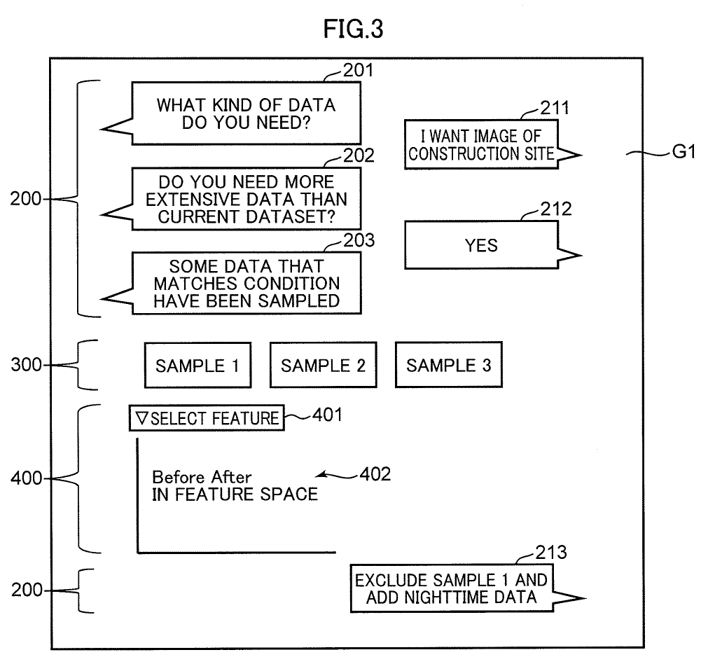

Here, the acquisition unit 11 may acquire the purpose information in an interactive form until information necessary for the search unit 13 to execute search processing is obtained. In this case, as illustrated in FIG. 3, the acquisition unit 11 is only required to interact with the user through a chat field 200 included in a presentation screen image G1 displayed on a display 41 of the terminal 40, and acquire the purpose information from the message input by the user. Alternatively, the acquisition unit 11 may display options for the purpose of data integration on the display 41 and acquire the purpose information from an item selected by the user. Note that “until information necessary for the search unit 13 to execute search processing is obtained” means “until information necessary for determining one or a plurality of search conditions constituting a search formula to be described later is obtained”.

The existing dataset includes a plurality of pieces of existing data owned by the user. The existing data is, for example, data collected by the user as learning data of machine learning. In the following description, it is assumed that the existing data is image data. However, this configuration is merely an example, and the existing data may be text data or audio data. The existing data is, for example, data related to a site such as in-home data, in-vehicle data, and factory data. An example of the in-home data is data indicating a motion of a person inside a house, utterance content, an operation status of an electric appliance, power consumption, a temperature, and the like. An example of the in-vehicle data is operation data of an automobile. Examples of the operation data of the automobile include a speed, an acceleration, a battery capacity, an electric current, a voltage, a fuel consumption, power consumption, a state of charge (SOC), and a temperature of the automobile. An example of the factory data is data indicating power consumption, temperature, operation data of various facilities, assembly status of parts, and the like. The existing data set is stored in the database 20 in advance in association with a user ID of the user owning the existing dataset.

The additional dataset includes a plurality of pieces of additional data. The additional data is candidate data finally selected as data to be added to the existing dataset from among candidate data stored in the database 20. In the following description, it is assumed that the additional data is image data. However, this configuration is merely an example, and the additional data may be text data or audio data.

The feature extraction unit 12 extracts feature amounts of the existing dataset and the candidate dataset. The feature amount includes a plurality of categorized feature amounts of different categories.

The categorized feature amount is a vector feature amount, meta information of image data, luminance distribution, annotation information, and the like. The vector feature amount is configured by, for example, a multidimensional vector obtained by inputting existing data and candidate data to a learned model machine-learned in advance to calculate the vector feature amount. In a case where the existing data and the candidate data include text data, the vector feature amount includes a word vector. In this case, as the vector feature amount, a word vector calculated by using a learned natural language processing model can be adopted. In a case where the existing data and the candidate data include audio data, the vector feature amount is calculated by using a learned model that converts the audio data into a vector.

As the meta information, a size (image size) of the image data, an aspect ratio of the image data, and acquisition date and time of the image data are adopted. The image size is represented by using, for example, the number of pixels of a width and the number of pixels of a height of the image data. The aspect ratio is a ratio between the width and the height of image data. The acquisition date and time is a photographing date and time of the image data.

The luminance distribution of the image data is data representing a frequency of each luminance of a plurality of pieces of pixel data constituting the image data.

The annotation information includes a class ratio, an annotation ratio, and an error rate. The class ratio is a ratio in the dataset of the class to which an object indicated by an annotation added to the image data belongs, for each dataset of the existing dataset and the additional candidate dataset. The annotation ratio is a ratio of the annotated image data in the dataset. The error rate is an error rate with respect to the annotation. The annotation is annotation information added to the image data as teacher data. The annotation includes, for example, a bounding box surrounding an object included in the image data and a tag indicating a class to which the object surrounded by the bounding box belongs. For example, in the case of image data in which an annotation is added to a dog, the annotation includes a bounding box surrounding the dog and a tag indicating that a class to which an object surrounded by the bounding box belongs is a dog.

For example, if the annotation is added to a dog, a cat, and a bird in a dataset, and the respective ratios are 10%, 10%, and 80%, the class ratio is 1:1:8. For example, if the ratio of the image data to which the annotation is added in the dataset is 30%, the annotation ratio is 30%. For example, in a case where the error rate is 50% when the image data to which the annotation is added is input to a recognizer, the error rate is 50%. For the error rate, a value measured in advance is associated with the image data.

The search unit 13 searches for an additional candidate dataset that matches the purpose of data integration from the candidate datasets on the basis of the purpose information acquired by the acquisition unit 11. The candidate dataset includes a plurality of pieces of candidate data. The candidate data is data that is stored in the database 20 in advance and is a candidate for the additional data. The candidate data includes big data accumulated by a company. For example, as the candidate data, data obtained by monitoring a house, an automobile, and a factory by using various sensors is adopted. Therefore, a large amount of candidate data is stored in the database 20. In the following description, it is assumed that the candidate data is image data. However, this configuration is merely an example, and the candidate data may be text data or audio data. The candidate data may be data related to a site such as in-home data, in-vehicle data, and factory data similarly to the existing data.

The search unit 13 compares the feature amount of the purpose information with the feature amount of the candidate data constituting the candidate dataset to search for an additional candidate dataset that matches the purpose.

Specifically, the search unit 13 calculates a matching degree for each of the plurality of conditions for each of the plurality of pieces of candidate data constituting the candidate dataset, and calculates a matching score for the purpose of data integration for each of the plurality of pieces of candidate data from the calculated matching degree. The search unit 13 searches for, as an additional candidate dataset, a dataset including candidate data having a matching score exceeding a threshold.

The matching score is expressed by, for example, the following search formula.

$$Matching score = f ( s 1 , s 2 , … , si , … , sn ) \qquad ( 1 )$$

Here, f represents some function for synthesizing si. An example of the function f is a function of multiplying si. si represents a matching degree for each of the plurality of search conditions. i is an index designating a search condition.

As an example of the search condition, a condition of similarity to the keyword included in the purpose information can be adopted. In this case, the candidate data having a higher similarity between the vector feature amount of the keyword and the vector feature amount of the candidate data has a higher matching degree. The similarity is, for example, a vector distance or a cosine similarity.

As an example of the search condition, a condition of similarity or dissimilarity to the existing dataset can be adopted. For example, in a case where the purpose information includes a request message indicating “I want data for general-purpose recognition”, the candidate data having a greater dissimilarity of the vector feature amount to the existing dataset has a greater matching degree. As a result, candidate data including an object belonging to a class other than the class included in the existing dataset is searched for as additional candidate data. For example, the inverse of the similarity can be adopted as the dissimilarity. For example, in a case where a message indicating “I want data specialized for the current class” is included in the purpose information, the candidate data having a higher similarity of the vector feature amount to the existing dataset has a larger value of the matching degree. In this case, candidate data including an object belonging to the same class as the class included in the existing dataset is searched for as additional candidate data. In the case of calculating the similarity or dissimilarity between the vector feature amount of the existing dataset and the vector feature amount of the candidate data, the search unit 13 is only required to use a representative value of the vector feature amount of the existing dataset. As the representative value, an average value of the vector feature amounts of the existing data constituting the existing dataset can be adopted. Note that, in a case where a tag indicating a class is added to the candidate data, the search unit 13 may calculate the similarity or dissimilarity by using the vector feature amount of the text data included in the tag.

As an example of the search condition, a filtering condition can be adopted. For example, in a case where the image size is designated as the filtering condition in the purpose information, the search unit 13 is only required to calculate the matching degree of the candidate data satisfying the specified filtering condition as “1” and the matching degree of the candidate data not satisfying the filtering condition as “0”.

In a case where these three search conditions are used, the matching score is expressed by the following search formula.

$$Matching score = f ( s 1 \times s 2 \times s 3 ) \qquad ( 2 )$$

The matching degree s1 indicates the similarity to the keyword, the matching degree s2 indicates the similarity or dissimilarity to the existing dataset, and the matching degree s3 indicates a value as to whether the filtering condition is satisfied. For example, in a case where the filtering condition is a condition related to the image size (for example, 640×480 pixels or more), the matching degree s3 of the candidate data satisfying the filtering condition is “1”, and the matching degree s3 of the candidate data not satisfying the filtering condition is “0”.

Here, the image size is indicated as the filtering condition, but this configuration is merely an example, and meta information other than the image size may be adopted. For example, “the aspect ratio is equal to or greater than a predetermined value” and “the period of the acquisition date and time of the image data” may be adopted as the filtering conditions.

The screen image generation unit 14 generates a presentation screen image visualizing a feature of an integrated dataset obtained by adding the additional candidate dataset to the existing dataset, and outputs the generated presentation screen image to the display 41 of the terminal 40.

The screen image generation unit 14 calculates a first distribution indicating a distribution of the feature amount of the existing data constituting the existing dataset in a feature space and a second distribution indicating a distribution of the feature amount of the integrated data constituting the integrated dataset in the feature space, and displays a presentation screen image including the first distribution and the second distribution on the display 41.

In a case where an instruction to select one categorized feature amount from among a plurality of categorized feature amounts is received, the screen image generation unit 14 may calculate the first distribution and the second distribution for one categorized feature amount and display a presentation screen image including the calculated first distribution and second distribution on the display 41.

The screen image generation unit 14 may cluster the integrated dataset into a plurality of clusters, determine a sample for each of the plurality of clusters from the clustering result, and include the determined plurality of samples in the presentation screen image. As a clustering method, a clustering method using a Gaussian mixture distribution or the like can be adopted. The screen image generation unit 14 is only required to calculate a center of gravity of the distribution of the feature amounts of the additional candidate dataset for each of the plurality of clusters, and determine the additional candidate data closest to the calculated center of gravity as a sample.

In a case where a user's instruction to designate an unnecessary sample from a plurality of samples is acquired by the acquisition unit 11, the screen image generation unit 14 may delete the additional candidate data included in the cluster to which the unnecessary sample belongs from the additional candidate dataset, update the integrated dataset by using the additional candidate dataset from which the additional candidate data has been deleted, and update the presentation screen image displayed on the display 41 by using the updated integrated dataset.

In a case where the acquisition unit 11 acquires additional purpose information with respect to the data integration, the search unit 13 may re-search for the additional candidate dataset from the candidate dataset on the basis of the additional purpose information, update the integrated dataset by using the re-searched additional candidate dataset, and update the presentation screen image displayed on the display 41 by using the updated integrated dataset. The additional purpose information is purpose information additionally input by the user who has browsed the presentation screen image. For example, the user who has confirmed from the presentation screen image that the ratio of the annotated image data in the candidate data included in the additional candidate dataset is low inputs a message to increase the number of annotated images as the additional purpose information. For example, the user who has confirmed from the presentation screen image that the ratio of a certain class in the additional candidate dataset is low inputs a message to increase the class having a low ratio as the additional purpose information. For example, the user who has confirmed from the presentation screen image that the image data of a certain image size or more among the additional candidate data included in the additional candidate dataset is insufficient inputs a message indicating that the user wants image data of the image size or more as the additional purpose information.

In a case where a confirmation instruction indicating that the additional candidate data is confirmed as the additional data is input by the user by using an operation unit 43 and the acquisition unit 11 acquires the confirmation instruction by using the communication unit 30, the integration unit 15 confirms the additional candidate dataset searched for at that time as the additional dataset. Then, the integration unit 15 performs data integration of adding the confirmed additional dataset to the existing dataset. In this case, the integration unit 15 determines the integrated dataset obtained by adding the additional dataset to the existing dataset as a final integrated dataset, assigns a user ID to the final integrated dataset, and stores the final integrated dataset in the database 20.

The database 20 is configured by, for example, a nonvolatile storage device, and stores the candidate dataset, the existing dataset, and the final integrated dataset.

The communication unit 30 is configured by a communication circuit that connects the server 1 to the network NT. The communication unit 30 receives the purpose information, the confirmation instruction, and the like transmitted from the terminal 40. The communication unit 30 transmits display data of the presentation screen image to the terminal 40.

The terminal 40 includes the display 41, the processor 42, the operation unit 43, and the communication unit 44. The display 41 is configured by, for example, a liquid crystal display panel, and displays the presentation screen image. The processor 42 controls the terminal 40. The operation unit 43 is configured by an input device such as a keyboard and a touch panel. The operation unit 43 receives an input of the purpose information. The communication unit 44 is a communication circuit that connects the terminal 40 to the network NT. The communication unit 30 receives display data of the presentation screen image transmitted from the server 1 and transmits the purpose information received by the operation unit 43 to the server 1.

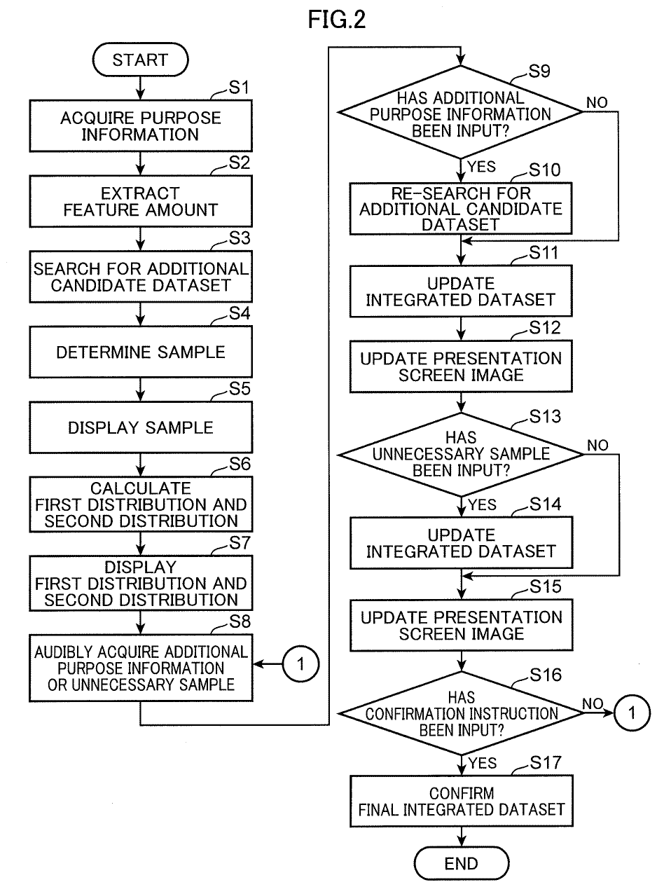

FIG. 2 is a flowchart illustrating one example of processing of the server 1 according to the present embodiment. Note that it is assumed that the acquisition unit 11 has acquired the user ID of the user who uses the terminal 40 before this flowchart is implemented.

In step S1, the acquisition unit 11 acquires the purpose information input by the user in the terminal 40.

Next, in step S2, the feature extraction unit 12 extracts feature amounts for all the existing data constituting the existing dataset and extracts feature amounts for all the candidate data constituting the candidate dataset. In this case, the feature extraction unit 12 is only required to extract all the categorized feature amounts for all the existing data and extract all the categorized feature amounts for all the candidate data. Here, the existing dataset to be used is an existing dataset of the user who uses the terminal 40, and is specified from the user ID.

Next, in step S3, the search unit 13 searches for, as additional candidate data, candidate data that matches the purpose indicated by the purpose information from the candidate dataset on the basis of the purpose information acquired in step S1. In this case, the search unit 13 is only required to calculate a matching score for each candidate data by using a search formula as shown in Formula (1), and search for candidate data having a matching score exceeding a threshold as additional candidate data. For example, in a case where a message indicating that a bird image is desired and a message indicating “I want data for general-purpose recognition” are included as the purpose information, the search formula is the matching score=f(s1×s2). However, the matching degree s1 indicates similarity to a keyword of a bird, and the matching degree s2 indicates dissimilarity to the existing dataset.

Next, in step S4, the screen image generation unit 14 clusters the additional candidate data searched for in step S3 into a plurality of clusters, and determines a sample for each of the plurality of clusters from the clustering result.

Next, in step S5, the screen image generation unit 14 displays the plurality of samples on the display 41 by transmitting display data for displaying the plurality of samples determined in step S4 on the presentation screen image to the terminal 40 by using the communication unit 30.

Next, in step S6, the screen image generation unit 14 calculates the first distribution indicating the distribution of the feature amounts in the feature space of the existing data constituting the existing dataset and the second distribution indicating the distribution of the feature amounts in the feature space of the integrated data constituting the integrated dataset.

Next, in step S7, the screen image generation unit 14 displays the first distribution and the second distribution on the display 41 by transmitting display data for displaying the first distribution and the second distribution calculated in step S6 in the presentation image to the terminal 40 by using the communication unit 30.

Next, in step S8, the audibly acquired message of the additional purpose information or the unnecessary sample is transmitted to the terminal 40 by using the communication unit 30. As a result, messages such as “Any unnecessary sample?” and “Any additional request?” are displayed on the display 41.

Next, in step S9, the acquisition unit 11 determines whether additional purpose information has been input. In this case, in a case where the additional purpose information has been input (YES in step S9), the processing proceeds to step S10, and in a case where the additional purpose information has not been input (NO in step S9), the processing proceeds to step S11.

Next, in step S10, the search unit 13 re-searches for the additional candidate dataset by using the additional purpose information. For example, in a case where a message indicating that an image of a predetermined size or more is desired is included as the additional purpose information, the search unit 13 is only required to re-search for the additional candidate dataset using a search formula in which a search condition of “the image size is the predetermined size or more” is added to the search formula used in the previous search. In the above example, the search formula is, for example, the matching score=f(s1×s2×s3). In this case, the matching degree s1 indicates the similarity to the keyword of a bird, the matching degree s2 indicates the dissimilarity of the candidate data to the existing dataset, and the matching degree s3 indicates a value (“1” or “0”) as to whether the filtering condition that “the image size is the predetermined size or more” is satisfied.

Next, in step S11, the search unit 13 updates the integrated dataset with the re-searched additional candidate dataset.

Next, in step S12, the screen image generation unit 14 updates the presentation screen image by using the updated integrated dataset. In this case, the screen image generation unit 14 is only required to update the second distribution displayed on the display 41 by using the updated integrated dataset. Furthermore, the screen image generation unit 14 is only required to cluster the updated integrated dataset into a plurality of clusters, determine a sample for each of the plurality of clusters from the clustering result, and update the sample of the presentation screen image with the determined sample.

Next, in step S13, the acquisition unit 11 determines whether the unnecessary sample has been input. In a case where the unnecessary sample has been input (YES in step S13), the processing proceeds to step S14, and in a case where the unnecessary sample has not been input (NO in step S13), the processing proceeds to step S15.

Next, in step S14, the screen image generation unit 14 updates the integrated dataset by deleting the additional candidate dataset belonging to the same cluster as the designated unnecessary sample from the integrated dataset.

Next, in step S15, the screen image generation unit 14 updates the presentation screen image by using the integrated dataset updated in step S14. In this case, similarly to step S12, the screen image generation unit 14 is only required to update the second distribution and the sample by using the updated integrated dataset.

Next, in step S16, in a case where the confirmation instruction is acquired by the acquisition unit 11 (YES in step S16), the integration unit 15 confirms the currently searched additional candidate dataset as the additional dataset, and confirms the integrated data obtained by adding the confirmed additional dataset to the existing dataset as the final integrated dataset (step S17).

On the other hand, in a case where the confirmation instruction is not acquired by the acquisition unit 11 (NO in step S16), the processing returns to step S8, and the processing in and after step S8 is executed. By repeating the processing of steps S8 to S16, an integrated dataset suitable for a task that the user desires to solve is generated while interactively incorporating the user's request for data integration.

FIG. 3 is a diagram illustrating an example of the presentation screen image G1. The presentation screen image G1 includes the chat field 200, a sample field 300, and a map field 400. The chat field 200 is a field in which the user inputs the purpose information. The chat field 200 allows the user to input the purpose information in an interactive form. In the chat field 200, a left column indicates a server side message, and a right column indicates a user side message. The server side message includes a message generated by the acquisition unit 11 to prompt the user to input the purpose information. The user side message includes an answer message of the user to the server side message, and the like.

In this example, first, the acquisition unit 11 displays a message 201 to inquire the user about the purpose of the data integration, such as “What kind of data do you need?”. In response to this question, the user inputs a message 211 indicating “I want an image of a construction site” by using the operation unit 43.

Next, the acquisition unit 11 displays a message 202 indicating “Do you need more extensive data than the current dataset?”. In response to this message, the user inputs “Yes” which is a message 212 of agreement by using the operation unit 43. Through these conversations, the acquisition unit 11 acquires the purpose information including the keyword “construction site” and the message indicating that versatile data is desired. With the acquisition of the purpose information, the search unit 13 sets a search formula as follows.

$$Matching score = f ( s 1 \times s 2 ) \qquad ( 3 )$$

However, the matching degree s1 indicates the similarity of the candidate data to the keyword “construction site”, and the matching degree s2 indicates the dissimilarity of the candidate data to the existing dataset. Next, the search unit 13 calculates a matching score of each of the plurality of pieces of candidate data stored in the database 20 by using this search formula, and searches for a dataset including the candidate data having a matching score exceeding the threshold as the additional candidate dataset.

The map field 400 includes a selection field 401 and a map display field 402. The selection field 401 allows the user to select one categorized feature amount from among a plurality of categorized feature amounts. The map display field 402 displays the first distribution and the second distribution for the one categorized feature amount selected from the selection field 401.

When the user inputs an operation of selecting the selection field 401 by using the operation unit 43, the selection field 401 displays a pull-down menu displaying a list of a plurality of categorized feature amounts. The user uses the operation unit 43 to input an operation of selecting one categorized feature amount from among the plurality of listed categorized feature amounts. Then, a selection instruction indicating the selected one categorized feature amount is transmitted from the terminal 40 to the server 1, and the acquisition unit 11 acquires the selection instruction. The screen image generation unit 14 calculates the first distribution and the second distribution for the selected one categorized feature amount, and transmits display data for displaying the first distribution and the second distribution on the presentation screen image G1 to the terminal 40 by using the communication unit 30. As a result, the map display field 402 displays the first distribution and the second distribution for one categorized feature amount. Note that, in an initial state, the map display field 402 displays the first distribution and the second distribution for one default categorized feature amount (for example, the vector feature amount).

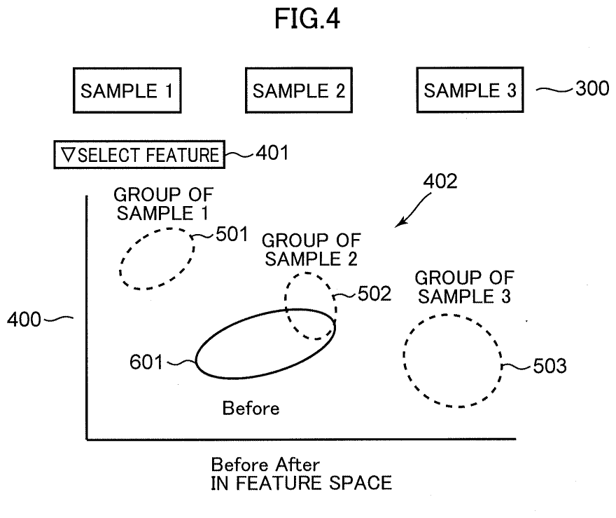

FIG. 4 is a diagram illustrating details of the sample field 300 and the map field 400. The map display field 402 displays the first distribution and the second distribution in a display form using two-dimensional coordinate axes. Here, the vector feature amount is selected as one categorized feature amount. A distribution 601 indicates the first distribution, and distributions 501, 502, and 503 indicate the second distributions. Since the distribution 601 indicates the distribution of the vector feature amounts related to the existing dataset, the message “before” is displayed near the distribution 601. The distributions 501 to 503 indicate distributions of vector feature amounts for each cluster of the integrated dataset clustered into three clusters. Specifically, the distribution 501 indicates a distribution of vector feature amounts in a cluster to which sample 1 belongs, the distribution 502 indicates a distribution of vector feature amounts in a cluster to which sample 2 belongs, and the distribution 503 indicates a distribution of vector feature amounts in a cluster to which sample 3 belongs. Therefore, “group of sample 1” is described near the distribution 501, “group of sample 2” is described near the distribution 502, “group of sample 3” is described near the distribution 503, and a correspondence relationship between the distributions 501 to 503 and the three samples is clearly indicated.

The screen image generation unit 14 is only required to compress the number of dimensions of the vector feature amount of each of the existing data constituting the existing dataset and the integrated data constituting the integrated dataset into two dimensions to calculate the first distribution and the second distribution. Here, the vector feature amounts of the existing data and the integrated data are compressed into two dimensions, but may be compressed into three dimensions. In this case, the map display field 402 is only required to display the first distribution and the second distribution in a display form using three-dimensional coordinate axes.

The display forms of the first distribution and the second distribution displayed in the map display field 402 are different in accordance with one selected categorized feature amount. For example, in a case where the image size is selected as the one categorized feature amount, the screen image generation unit 14 is only required to display a histogram indicating a frequency corresponding to the image size in the existing dataset in the map display field 402 as the first distribution, and is only required to display a histogram indicating a frequency corresponding to the image size in the integrated dataset in the map display field 402 as the second distribution. The same applies to the aspect ratio and the acquisition date and time.

For example, in a case where the luminance distribution is selected as the one categorized feature amount, the screen image generation unit 14 is only required to display a histogram indicating a frequency corresponding to the luminance in the existing dataset as the first distribution, and is only required to display a histogram corresponding to the luminance in the integrated dataset in the map display field 402 as the second distribution.

For example, in a case where the class ratio is selected as the one categorized feature amount, the screen image generation unit 14 is only required to display a numerical value indicating the class ratio in the existing dataset in the map display field 402 as the first distribution, and is only required to display a numerical value indicating the class ratio in the integrated dataset in the map display field 402 as the second distribution. A display example of the class ratio is “The class ratios in the existing dataset are dog: 0.4 and cat: 0.1, and the class ratios in the integrated dataset are dog: 0.4, cat: 0.1, and crow: 0.2”.

For example, in a case where the annotation ratio is selected as the one categorized feature amount, the screen image generation unit 14 is only required to display a numerical value indicating the annotation ratio in the existing dataset in the map display field 402 as the first distribution, and is only required to display the annotation ratio in the integrated dataset as the second distribution. A display example of the annotation ratio is “The ratio of annotated data in the existing dataset is 0.5, and the ratio of annotated data in the integrated dataset is 0.4”.

For example, in a case where the error rate is selected as the one categorized feature amount, the screen image generation unit 14 is only required to display a histogram indicating a frequency corresponding to the error rate in the existing dataset in the map display field 402 as the first distribution, and is only required to display a histogram indicating a frequency corresponding to the error rate in the integrated dataset in the map display field 402 as the second distribution.

In the example of FIG. 4, since the integrated dataset has been clustered into three clusters, the three distributions 501 to 503 are displayed. However, in a case where the integrated dataset has been clustered into two clusters, two distributions are displayed as the second distributions, and in a case where the integrated dataset has been clustered into four or more clusters, four or more distributions are displayed as the second distributions.

See FIG. 3 again. A message 213 to “exclude sample 1 and add nighttime data” is input by using the operation unit 43 by the user who has browsed the sample field 300 and the map field 400. Thus, the acquisition unit 11 acquires, as additional purpose information, purpose information including two messages to “exclude sample 1” and to “add nighttime data”. The search unit 13 reflects the search conditions corresponding to these two pieces of purpose information in the search formula used in the previous search. The search formula in this case is as follows.

$$Matching score = f ( s 1 \times s 2 \times s 3 \times s 4 ) \qquad ( 4 )$$

In this search formula, matching degrees s3 and s4 are added to the search formula shown in Formula (3). The matching degree s3 indicates the similarity to the luminance distribution at a predetermined nighttime, and the matching degree s4 indicates the value of “0” for the additional candidate data belonging to sample 1 and the value of “1” for the additional candidate data not belonging to sample 1.

The search unit 13 calculates a matching score of the candidate data stored in the database 20 by using the search formula (4), and searches for a dataset including the candidate data having a matching score exceeding the threshold as the additional candidate dataset. Then, the screen image generation unit 14 updates the integrated dataset by using the searched additional dataset, and updates the sample displayed in the sample field 300 and the second distribution displayed in the map field 400 by using the updated integrated dataset.

In a case where an additional candidate dataset that finally satisfies the user is obtained by repeating such work, the user inputs a message indicating a confirmation instruction to the chat field 200. As a result, the additional candidate dataset searched for at this time point is determined as the additional dataset.

As described above, in the present embodiment, the additional candidate dataset that matches the purpose indicated by the purpose information is searched for from the candidate dataset on the basis of the purpose information, and the presentation screen image visualizing the feature of the integrated dataset obtained by adding the candidate dataset to the existing dataset is output to the display. Therefore, the user can know an influence of the additional candidate dataset on the existing dataset through the presentation screen image and confirm whether the additional candidate dataset matches the purpose. As a result, the present disclosure allows data integration that matches the purpose of the user to be implemented.

Modifications described below can be adopted for the present disclosure.
(1) In the above embodiment, the purpose information is input in an interactive form, but the present disclosure is not limited to this example, and the purpose information may be input in a selective form. In this case, the acquisition unit 11 is only required to acquire the purpose information by displaying the options related to the purpose information of the presentation screen image G1 in advance and allowing the user to select an option. Examples of the options include a selection field for selecting whether data for general-purpose recognition is desired or data specialized for the current class is desired, and a selection field for selecting an image size.
(2) In FIG. 4, the map display field 402 graphically displays the first distribution and the second distribution, but this configuration is an example, and the first distribution and the second distribution may be displayed by using numerical values. For example, in relation to the luminance distribution, the map display field 402 may display an average value of modes of the luminance of the existing data included in the existing dataset as the first distribution, and may display an average value of modes of the luminance of the integrated data included in the integrated dataset as the second distribution.
(3) Although the search unit 13 compares the matching score with the threshold, the present disclosure is not limited to this example. The search unit 13 may rank the candidate data stored in the database 20 in descending order of the matching score, and search for the candidate data ranked higher than a predetermined rank as the additional candidate data.

(4) In FIG. 1, the data integration assistance device is configured by the server 1, but may be configured by the terminal 40. In this case, the acquisition unit 11 to the integration unit 15 and the database 20 are only required to be included in the terminal 40. The acquisition unit 11 to the integration unit 15 may be disposed in a distributed manner between the server 1 and the terminal 40.

### INDUSTRIAL APPLICABILITY

The present disclosure is useful in the technical field of machine learning.

1. A data integration assistance method comprising:
by a computer,
acquiring purpose information indicating a purpose of a user with respect to data integration in which an additional dataset is added to an existing dataset owned by the user,
searching for an additional candidate dataset that matches the purpose from candidate datasets on a basis of the purpose information,
generating a presentation screen image visualizing a feature of an integrated dataset obtained by adding the additional candidate dataset to the existing dataset, and
outputting the presentation screen image to a display.

2. The data integration assistance method according to claim 1, wherein the presentation screen image includes a first distribution indicating a distribution of feature amounts of existing data constituting the existing dataset in a feature space, and a second distribution indicating a distribution of feature amounts of integrated data constituting the integrated dataset in the feature space.

3. The data integration assistance method according to claim 1, wherein the presentation screen image includes a plurality of samples for each of a plurality of clusters of the integrated dataset, the plurality of samples being obtained by clustering the integrated dataset into the plurality of clusters.

4. The data integration assistance method according to claim 3, further comprising:
in a case where an instruction of the user to designate an unnecessary sample from the plurality of samples is received, deleting additional candidate data included in a cluster to which the unnecessary sample belongs from the additional candidate dataset; and
updating the integrated dataset by using the additional candidate dataset having been deleted, and updating the presentation screen image by using the integrated dataset having been updated.

5. The data integration assistance method according to claim 1, further comprising:
in a case where additional purpose information with respect to the data integration is acquired, re-searching for the additional candidate dataset from the candidate dataset on a basis of the additional purpose information; and
updating the integrated dataset by using the additional candidate dataset having been re-searched for, and updating the presentation screen image by using the integrated dataset having been updated.

6. The data integration assistance method according to claim 1, wherein the searching includes searching for an additional candidate dataset that matches the purpose by comparing a feature amount of the purpose information with a feature amount of candidate data constituting the candidate dataset.

7. The data integration assistance method according to claim 1, wherein
the searching includes
calculating a matching degree for each of a plurality of search conditions for each of a plurality of the candidate data constituting the candidate dataset, and combining the matching degrees to calculate a matching score for the purpose for each of the plurality of candidate data, and
searching for, as the additional candidate dataset, a dataset including the candidate data having a matching score exceeding a threshold.

8. The data integration assistance method according to claim 1, wherein
the feature amount includes a plurality of categorized feature amounts of different categories, and
in a case where an instruction to select one categorized feature amount from the plurality of categorized feature amounts is received, the presentation screen image displays the feature of the integrated dataset for the one categorized feature amount.

9. The data integration assistance method according to claim 7, wherein
each of the existing dataset and the candidate dataset includes image data, and
the plurality of categorized feature amounts includes at least two of a vector feature amount obtained by inputting the image data to a learned model, meta information of the image data, a luminance distribution of the image data, or annotation information.

10. The data integration assistance method according to claim 9, wherein the meta information includes at least one of a size of the image data, an aspect ratio of the image data, or an acquisition date and time of the image data.

11. The data integration assistance method according to claim 9, wherein
the annotation information includes, for each dataset of the existing dataset and the additional candidate dataset,
at least one of a ratio of a class to which an object indicated by an annotation added to the image data belongs in the dataset, a ratio of the image data having been annotated in the dataset, or an error rate of the annotation in the dataset.

12. The data integration assistance method according to claim 1, wherein each of the existing dataset and the additional dataset is a dataset for machine learning.

13. The data integration assistance method according to claim 2, wherein the second distribution includes a plurality of distributions corresponding to a plurality of the clusters obtained by clustering the additional candidate data constituting the additional candidate dataset.

14. A data integration assistance device comprising a processor, wherein
the processor
acquires purpose information indicating a purpose of a user with respect to data integration in which an additional dataset is added to an existing dataset owned by the user,
searches for an additional candidate dataset that matches the purpose from candidate datasets on a basis of the purpose information,
generates a presentation screen image visualizing a feature of an integrated dataset obtained by adding the additional candidate dataset to the existing dataset, and
outputs the presentation screen image to a display.

15. A non-transitory computer readable recording medium storing a data integration assistance program causing a computer to execute processing of
acquiring purpose information indicating a purpose of a user with respect to data integration in which an additional dataset is added to an existing dataset owned by the user,
searching for an additional candidate dataset that matches the purpose from candidate datasets on a basis of the purpose information,
generating a presentation screen image visualizing a feature of an integrated dataset obtained by adding the additional candidate dataset to the existing dataset, and
outputting the presentation screen image to a display.
